(19) United States
(12) Patent Application Publication
(10) Pub. No.: US 2008/0100848 A1
(43) Pub. Date: May 1, 2008

(54) Optical tomograph

(76) Inventor: Koji Kobayashi, Tokyo (JP)

Correspondence Address: BRUCE L. ADAMS, ESQ., SUITE 1231, 17 BATTERY PLACE, NEW YORK, NY, 10004, US

(21) Appl. No.: 11/586,129

(22) Filed: Oct. 25, 2006

(51) Int. Cl. G01B 11/02; G01B 9/02

(52) U.S. Cl. 356/497; 356/479

(57) ABSTRACT

A partially coherent light beam from a light source is split between a probe light beam toward an observation object and a reference light beam toward a fixed reflective surface. The frequency of the probe light beam is shifted by optical-modulation means. The probe light beam whose frequency has been shifted is swept in a direction of an optical axis and in a direction orthogonal thereto to scan the object two-dimensionally. Reflected light beam from the object is combined with the reference light beam to generate interference light. A detector receives a time-based interference signal from the interference light obtained from the movement of the probe light beam in the direction of the optical axis and the sweeping in the direction orthogonal to the optical axis to derive therefrom reflection intensity data of the object. In such a configuration, the mechanically moving portion is disposed in the probe optical path. Therefore, changes in the interference characteristics of the light that accompany the mechanical scanning are less likely to occur and optical adjustments are also made easy.

### BACKGROUND OF THE INVENTION

1. Field of the Invention

The present invention relates to an optical tomograph, and more specifically relates to an optical tomograph for obtaining tomographic imaging data of an observation object by sweeping a light beam from a light source to scan a prescribed region of the object, and detecting and processing reflected light from the object by using optical interference.

2. Description of the Prior Art

In prior art, a device for imaging tomographic data (optical coherence tomography: OCT) of an observation object by using the interference of a low-interference light beam (partially coherent light) can create and display an arbitrary tomographic image of an observation object in a noncontact, noninvasive manner. Therefore, optical tomographs are particularly useful in medical imaging and are beginning to be used in general clinical examinations in ophthalmology, as well as in dermatological diagnoses, endoscopic applications, and other medical fields. The tomographs are also being studied for their use as special testing equipment in the industry.

As an example of an early OCT, Japanese Laid-open Patent Application 1992-174345 discloses that reference light is generated by shifting the frequency of emitted light and combined with light reflected from a measurement light to produce a beat component, which is then detected to create a reflected tomographic image of the object.

Japanese Laid-open PCT Application 1994-511312 discloses a configuration having an interferometer that uses an optical fiber and a light source having short coherence length characteristics, phase modulating means and a transverse scanning mechanism that are disposed in an optical path of probe light directed toward a sample, an ultrasonic light-modulating element disposed in the optical path of reference light, movement control means for the length of the optical path in the direction of the optical axis, and the like. In this configuration, a tomographic image of the sample is created by detecting and processing interference light of the probe light and reference light that are passed through the optical fiber.

Japanese Laid-open Patent Application 2000-126188 discloses a configuration wherein an optical tomograph having an optical fiber interferometer and a light source for generating low-interference light is combined with the end of an endoscope, a celoscope, or the like via one of the optical paths of the interferometer. The document discloses a technique in which an endoscope or the like that is inserted into a body cavity is used to make it possible to create a two-dimensional reflected image with the aid of CCDs or other devices provided as conventional observation devices, and to create a tomographic image of affected tissue in the depth direction by detecting and processing an interference signal obtained via the interferometer.

Japanese Laid-open Patent Application 1996-206075 discloses a configuration wherein a tomographic image of the cornea of an eye being examined is obtained by dividing a light beam from a light source between a sample beam path and a reference beam path, then superposing light that returns via the two paths, guiding the light along a detection beam path, and processing the interference signal obtained by a detector. The document also discloses a technique in which, to reduce the data collection time, a helical mirror that is placed in the reference beam path (reference optical path) is rotated to vary the length of the optical path for scanning along the optical axis, and the reflective mirror disposed within the reference optical path is moved to match a depth scan to the curvature of the cornea.

Japanese Laid-open Patent Application 1998-332329 discloses a configuration comprising a semiconductor laser light source whose light frequency can be swept, a Michelson interferometer and a one- or two-dimensional image pickup device, wherein an image signal that is output when the light frequency is being swept is subjected to a Fourier transformation, and a tomographic picture is calculated. According to this document, an advantage is obtained whereby the use of a scanning mechanism in conjunction with mechanical movement in the direction of the optical axis is not necessary, and a stable interference optical system can be constructed and rapid measurements conducted because the data in the depth direction can be obtained by sweeping the light frequency of the light source.

Japanese Laid-open Patent Application 2003-93346 discloses a configuration in which a spatially spread out light beam is split by a beam splitter between reference light and measurement light, and the measurement light is directed to the eye being examined as a measurement object. The reflected light from the eye being examined interferes with the reference light that has passed through the reference optical path to allow spatial data to be simultaneously obtained via a two-dimensional detector array.

In this configuration, measurement light is guided through an optical system (rear guide reflector) composed of two mirrors, and a scan in the depth direction is recorded in accordance with the movement of the rear guide reflector in the direction of the optical axis.

However, the configurations disclosed in Japanese Laid-open PCT Application 1994-511312 and in Japanese Laid-open Patent Applications 1992-174345, 2000-126188, 1996-206075, and 1998-332329 have a problem in that the focus state of the emitted light (sample light) directed to the observation object cannot be optimally maintained over the entire area of the tomographic picture, and the increase in the resolution in an in-plane direction orthogonal to the optical axis (depth direction) is also difficult to achieve due to the fact that the observation object is scanned in the depth direction by controlling the movement of the reflective mirror in the direction of the optical axis in relation to the reference light.

Additionally, the configuration disclosed in Japanese Laid-open Patent Application 1996-206075 has a problem in that the mechanism for the length/depthwise scanning of an object in the direction of the optical axis is disposed in the reference optical path so that the interferometer itself is readily subjected to the effects of vibration and mechanical feed errors, and the interference function is therefore readily affected by factors such as the axial wobbling of the rotating helical mirror that is used in scanning in the direction of the optical axis.

Furthermore, the configuration disclosed in Japanese Laid-open Patent Application 1998-332329 has a problem in that a special semiconductor laser light source that can stably control the frequency of light over a desired range is necessary, that light sources of this type are limited in variety and wavelength, and that the light sources themselves are expensive. In addition, when a one- or two-dimensional image pickup device is used as a detector, it becomes difficult to sufficiently reduce the size of the space filter disposed in the preceding optical path, and it is also difficult to completely remove unnecessary stray light from the sample.

Yet further, the configuration disclosed in Japanese Laid-open Patent Application 2003-93346 has a problem in that, although the resolution can be increased because the emitted light is focused on a predetermined portion of the object (eye to be examined) by the movement of the two mirrors, the effects of stray light and the like become pronounced due to the fact that spatial data is simultaneously detected at multiple points, making it difficult to improve the SN (signal to noise ratio) of the image.

Still yet further, in Japanese Laid-open PCT Application 1994-511312 and in Japanese Laid-open Patent Applications 2000-126188 and 1996-206075, an optical system that uses an optical fiber is disclosed. However, although it is a common opinion that using an optical fiber gives flexibility in arranging the optical path, there is a problem in that the precision optics and mechanical components for linking to the optical fiber are expensive.

Even further, in Japanese Laid-open Patent Applications 1998-332329 and 2003-93346, there is a problem in that the one- or two-dimensional image pickup device that is used to detect interference signals has low sensitivity when compared to a point-type optical detector such as a photomultiplier, and imparting higher sensitivity to the image pickup device is expensive.

Therefore, an object of the invention is to provide an optical tomograph with a simple configuration that allows cross-sectional images of an observation object to be observed at higher resolution and contrast.

### SUMMARY OF THE INVENTION

The present invention provides an optical tomograph for obtaining tomographic imaging data of an observation object by scanning a prescribed region thereof with a light beam from a light source, and detecting and processing reflected light from said object by using optical interference. The optical tomograph comprises a light source for generating a low-interference light beam; an optical splitting element for splitting the light beam from said light source into probe light toward the object and reference light toward a fixed reflective surface; light modulation means for shifting the frequency of the beam of said probe light; movement means for moving said frequency-shifted light beam in the direction of the optical axis; sweeping means for sweeping said frequency-shifted light beam in a direction orthogonal to the optical axis; detecting means for detecting interference light obtained from the reflected light from the object that has passed through said sweeping means, movement means, light modulation means and optical splitting element and interferes with the reference light that is reflected by said fixed reflective surface and guided via the optical splitting element; and processing means for processing a time-based interference signal obtained from the detecting means in accordance with the movement of the light beam in the direction of the optical axis and the sweeping in a direction orthogonal to the optical axis to derive therefrom reflection intensity data of the interior of the object.

The present invention also provides an optical tomograph, comprising a light source for generating a low-interference light beam of two or more differing wavelengths; an optical splitting element for splitting the light beam from said light source into probe light toward the object and reference light toward a fixed reflective surface; light modulation means for shifting the frequency of the beam of the probe light; movement means for moving said frequency-shifted light beam in the direction of the optical axis; sweeping means for at least one-dimensionally sweeping said frequency-shifted light beam in a direction orthogonal to the optical axis; light-guide means that is disposed between said optical splitting element and fixed reflective surface to set its optical path length equal to the length of the optical path traveled by said probe light; two or more detecting means tuned to the wavelength of the light source for detecting interference light obtained from the reflected light from the object that has passed through said sweeping means, movement means, light modulation means and optical splitting element and interferes with the reference light that is guided via the fixed reflective surface, light-guide means and optical splitting element; and processing means for processing a time-based interference signal obtained from the detecting means in accordance with the movement of the light beam in the direction of the optical axis and the sweeping in a direction orthogonal to the optical axis to derive therefrom reflection intensity data of the interior of the object.

According to the present invention, light-modulation means, means for moving the optically modulated beam in a depth direction along the optical axis, and sweeping means for sweeping the beam in a direction orthogonal thereto are disposed in the probe optical path for the observation object. Such an arrangement enables a tomographic image of an observation object to be viewed and displayed at a high resolution.

A suitable wavelength can be selected from among light sources whose wavelengths differ in accordance with the type of object, and an image having a higher resolution and contrast can therefore be obtained.

Light-modulation means, movement means, and sweeping means are all provided in the probe optical path for the object. Therefore, the optical system can be easily adjusted, mechanical movement errors have little effect on the interferometer, and stable characteristics can be maintained.

Even if the light beam is moved in the direction of the optical axis, a match will be maintained between the length of the optical path of the probe light up to the object focal point and the length of the optical path of the reference light up to the fixed reflective surface. Therefore, fluctuations in the detection efficiency of the interference signal can be minimized, and a high-contrast image at a high resolution can be obtained.

Point-type high-efficiency, high-sensitivity devices can be used for the light source and detector. Therefore, a highly dependable, practical, and economical optical tomograph can be provided by completely eliminating special parts from other main optical components within the optical path and completing the device in a relatively inexpensive manner.

Further features of the invention, its nature and various advantages will be more apparent from the accompanying drawings and following detailed description of the invention.

### BRIEF DESCRIPTION OF THE DRAWINGS

FIG. 1 is a structural view showing the optical system of the first embodiment of the optical tomograph according to the present invention;

FIG. 2 is a block diagram showing the configuration of a circuit for processing an electrical signal;

FIG. 3 is a structural view showing the optical system of the second embodiment of the optical tomograph according to the present invention; and

FIG. 4 is a waveform chart showing the relationship between the modulation means and the control of the light source.

### DESCRIPTION OF THE PREFERRED EMBODIMENTS

The invention will now be described in detail with reference to the embodiments shown in the drawings.

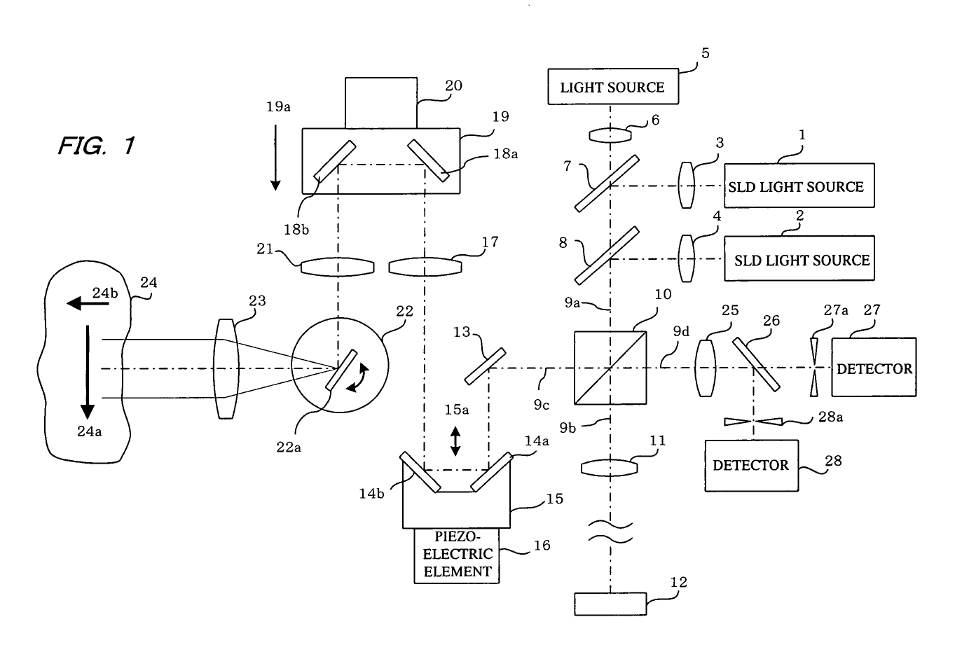

In FIG. 1, the objects indicated by reference numerals 1 and 2 are super luminescent diodes (SLD) for emitting partially coherent light. These diodes are light sources for generating a light beam that has low interference (little interference), which is necessary in observing a tomographic picture. The diodes emit light in different near-infrared (invisible) wavebands having emission wavelengths of, e.g., 1300 nm and 850 nm, respectively, and the light beams emitted from the light sources 1 and 2 are collimated by lenses 3 and 4, respectively.

In FIG. 1, an additional light source 5 is provided. This light source is a semiconductor laser for emitting red (visible) light having a wavelength of 670 nm, for example. The light source 5 is provided for the sake of convenience in order to verify the optical path of the beams from the invisible-light sources 1 and 2 by using the visible light. The light beam from the light source 5 is collimated by a lens 6, is combined with the light beams from the light sources 1 and 2 into a signal optical path 9a by dichroic mirrors 7 and 8, and is subsequently made incident on a beam splitter 10 that acts as an optical splitting element.

The incident optical path 9a is split in two between a reference optical path 9b and a probe optical path 9c by the beam splitter 10. The light beam that proceeds along the reference optical path 9b reaches a fixed mirror (fixed reflective surface) 12 via a lens 11 and is reflected therefrom. In this configuration, the optical path 9b of the reference light must be equivalent in optical path length to the optical path 9c of the probe light. For the sake of simplicity in the drawing, the distance from the beam splitter 10 to the fixed mirror 12 is shown only partially. In an actual system, however, the distance is set to the corresponding length.

The light beam that proceeds along the probe optical path 9c is reflected by mirrors 13, 14a and 14b. The mirrors 14a and 14b are connected to a piezoelectric element (piezoelectric vibrator) 16 via a fixing member 15. The vibrator 16 endows the mirrors 14a and 14b with micro-vibrations in the direction of the optical axis (the direction of the arrow 15a) at a high frequency of, for example, several tens of kilohertz or greater, and comprises light-modulating means for modulating (shifting the frequency of) the light beam.

The modulated light beam is reflected by mirrors 18a and 18b via a lens 17, and folded. The mirrors 18a and 18b are connected to a stepping motor 20 via a fixing member 19 that includes a movement rail and, along with the motor 20, comprise movement means for moving the light beam in the direction of the optical axis (arrow 19a). In other words, the location of the focal point (image-forming location) of the light beam is, for example, placed between the mirrors 18a and 18b by the lens 17, and the location of the focal point is moved in the direction of the optical axis by the movement of the mirrors 18a and 18b in the direction of the arrow 19a.

The light beam reflected by the mirrors 18a and 18b is incident via a lens 21 onto a galvanomirror 22a that is mounted to a galvanometer 22. The galvanomirror 22a is a sweeping means for one-dimensionally sweeping the beam in the direction orthogonal to the optical axis. The galvanomirror 22a allows a two-dimensional scan of an image together with a sweep of the beam made by the motor 20 in the direction of the optical axis. The scan performed by the galvanomirror 22a has a higher speed than does the scan performed by the motor 20, and the relationship between the scan periods (or frequencies) of the two sweeping means is determined by the desired number of scanning lines of the image. The swept light beam is focused onto a predetermined location on an observation object 24 via a lens 23, and the object 24 is two-dimensionally scanned in an in-plane direction 24a and a thickness direction 24b. As used herein, the in-plane direction 24a is the direction of scanning by the galvanometer 22a orthogonal to the direction of the optical axis. The depth direction 24b is the direction of scanning by the motor 20 along the optical axis. In the embodiment of FIG. 1, the observing object may be limb hypodermis or another biological sample, a food product or a plant sample, a component for the polymer industry, or any other object that transmits light to some degree.

Reflected light from the object 24 proceeds in reverse through the above-described optical system. In other words, the reflected light passes through the lens 23, the galvanomirror 22a, the lens 21, the mirrors 18b and 18a, the lens 17, and the mirrors 14b, 14a and 13 and reaches the beam splitter 10. Reflected light from the object 24 that is transmitted by the beam splitter 10 receives the high-frequency micro-vibrations of the mirrors 14a and 14b, so that it slightly differs in frequency from the reference light that is reflected by the fixed mirror 12 disposed in the reference optical path 9b and enters the beam splitter 10. The light from the object 24 is then combined with the reference light in the optical path 9d. This causes interference light to be generated due to the slight difference in the frequency of both the light beams. The interference signal component from the interference light is directed through a lens 25 and a dichroic mirror 26, and is detected by a detector (detecting means) 27 or 28 composed of a photodiode. It is possible to eliminate noise caused by unnecessary stray light and scattered light and improve the SN ratio of the interference signal by providing predetermined openings (pinholes) 27a and 28a on a front surface of the detectors 27 and 28.

The dichroic mirror 26 divides the optical path in accordance with the wavelength of the light source 1 or 2, and has the same characteristics as the dichroic mirror 8 described above. A photodiode exhibiting high sensitivity is selected for each of the detectors 27 and 28 in accordance with the wavelengths (e.g., 1300 nm and 850 nm) of the light source. For example, the selection can be made by coordinating the light source and either of the detectors in accordance with the type of object.

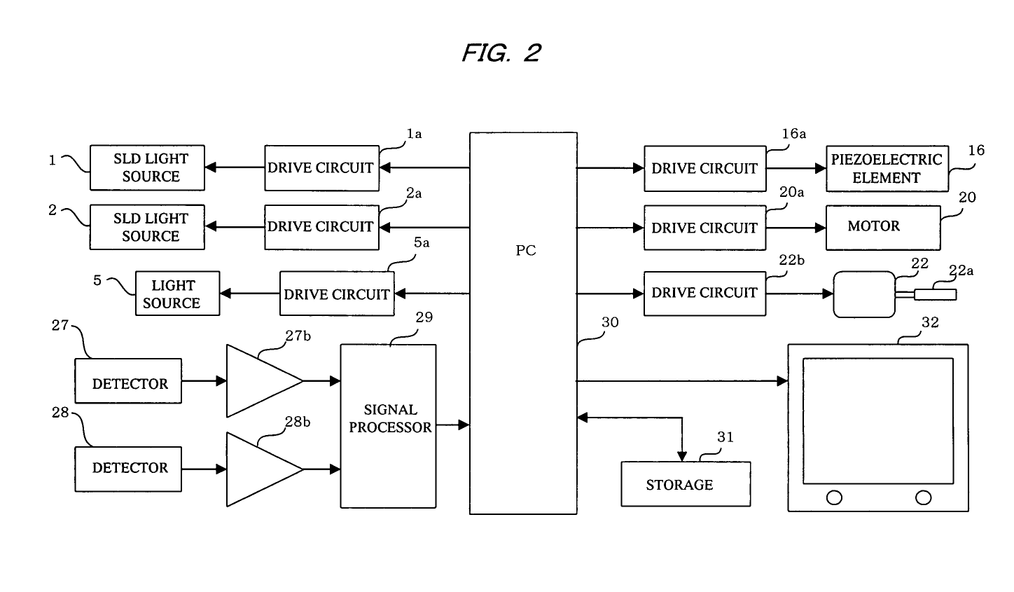

In FIG. 2, processing of the signals that are output from the detectors 27 and 28 is shown as a block diagram together with the other electrical processing systems. The outputs from the detectors 27 and 28 are amplified by amplifying circuits 27b and 28b, respectively, and are fed to a signal processing circuit 29. The signal processing circuit 29 includes a signal selecting circuit, a band-pass filter, a rectifying circuit, a low-pass filter, a logarithmic amplifying circuit, an A/D converter, and other electrical circuits for performing various processes. The signal processing circuit 29 is a processing means wherein interference light obtained from the scan in the direction orthogonal to the optical axis and the movement of the light beam in the direction of the optical axis is extracted as a time-based interference signal to produce reflection intensity data for the object (data from the interior of the object). The signal from the signal processing circuit 29 is fed to a computer (personal computer; PC) 30.

The computer 30 drives either of the light sources 1 and 2 via drive circuits 1a and 2a, respectively. The signal processing circuit 29 processes either of the outputs of the detector 27 and 28 in accordance with the selection of the light source (wavelength switching) and feeds the processed signal to the computer 30. Simultaneously with the above-described process, the computer 30 also controls a drive circuit 16a that is connected to the piezoelectric element 16, a drive circuit 20a that is connected to the motor 20, and a drive circuit 22b that is connected to the galvanometer 22. Furthermore, the computer 30, via a drive circuit 5a, optionally controls the switching on or off of the light source 5 for verifying the optical path of the light beam.

The interference signal component that is fed to the computer 30 via the signal processing circuit 29 indicates the intensity data of the reflected light from the interior of the observed object by using the interference optical system described in FIG. 1. The computer 30 can reconstruct an image synchronously with the sweep of the light beam (in-plane scanning by the galvanometer 22a and scanning in the direction of the optical axis by the mirrors 18a and 18b). The tomographic picture constructed by the computer 30 can be, as necessary, stored in a storage 31 or graphically displayed along with various associated data, text data, and the like on a monitor of a display device 32 (e.g., a liquid crystal television monitor).

In configurations such as those of FIGS. 1 and 2, either of the SLD light sources 1 and 2 is selectively switched on via the control of the computer 30 in accordance with the characteristics of the observation object 24. After being collimated by the lens (3 or 4), the light beam emitted from the light source is made incident on the beam splitter 10 via the dichroic mirror (7 or 8). At this time, the light source 5 can also be lighted in order to verify the optical path of the beam by using visible light.

As has already been described, the beam is divided by the beam splitter 10, and the light beam that proceeds along the reference optical path 9b reaches the fixed mirror 12 via the lens 11 and is reflected thereon. Meanwhile, the light beam that proceeds along the probe optical path 9c is reflected by the mirrors 13, 14a and 14b and is then modulated (frequency-shifted), due to the mirrors 14a and 14b being endowed with micro-vibrations by the piezoelectric element 16. The modulated light beam is reflected by the mirrors 18a and 18b via the lens 17, passes through the lens 21, is made incident on the galvanomirror 22a, and is focused onto the object 24 via the lens 23.

The galvanomirror 22a oscillates around the axis extending perpendicular to the drawing, and the light beam therefore moves on the observation object 24 reciprocatingly in the direction of the arrow 24a. In addition, when the motor 20 is operated to move the mirrors 18a and 18b in the direction of the arrow 19a, the location of the focal point in the depth direction of the light beam on the object 24 (the image point of the light beam; i.e., the location in the depth direction where the radius of the light beam is smallest) is moved in the direction of the arrow 24b (the depth direction). Therefore, the location of the focal point of the light beam is two-dimensionally moved over the object 24 by the scanning performed by the galvanomirror 22a and the scanning performed by the motor 20 (the mirrors 18a and 18b).

In accordance with the sweeping of the light beam, reflected light from the object 24 passes through the lens 23, the galvanomirror 22a, the lens 21, the mirrors 18b and 18a, and the lens 17; is reflected by the mirrors 14b, 14a and 13; penetrates the beam splitter 10; and is combined with reference light that is reflected by the beam splitter 10. This causes interference light to be generated in the optical path 9d. At this time, reflected light from the object 24 is subjected to the high-frequency micro-vibrations of the mirrors 14a and 14b and shifts in frequency. Because its frequency is slightly different from that of the reference light, a beat is created in the interference light. The interference light (beat signal) is directed through the lens 25, the dichroic mirror 26, and the predetermined detection openings (27a, 28a); detected by the detector (27 or 28); and extracted.

Even if the location of the focal point of the light beam (focal point on the object) in the depth direction is altered by the scan by the motor 20, the distance from that location to the beam splitter 10 along the optical axis will not change. This makes it possible in an interference optical system to make the length of the optical path of the probe light equal to the length of the optical path of the reference light. Therefore, in such a system, the focal relationship between the focal point on the object and the detection opening (location of the focal point of the interference light) remains consistently stable, and the resolution at the scanning locations and detection efficiency can be optimally maintained.

The signal processing circuit 29 selects and processes a signal from either of the detectors 27 and 28 depending upon the selection of the light sources 1 and 2, extracts the intensity data of the reflected light of the interior of the object from the interference signal, and feeds the results to the computer 30. The reflection intensity data is successively fed to the computer 30 in accordance with a two-dimensional scan comprising the in-plane sweep of the light beam by the galvanomirror 22a and the sweep performed by the mirrors 18a and 18b in the direction of the optical axis. Therefore, the computer 30 reconstructs a cross-sectional picture of the object from the intensity data of the scanned points in synchronization with the two-dimensional sweeps of the light beam, and either displays the image on the display device 32, or stores the image in the storage 31.

In this embodiment, the light beam two-dimensionally scans the object 24 only within the page space of the drawing. However, stereoscopic tomographic picture data can also be obtained by providing another galvanomirror and performing a three-dimensional scan by sweeping in the direction orthogonal to the light beam swept by the galvanomirror 22a.

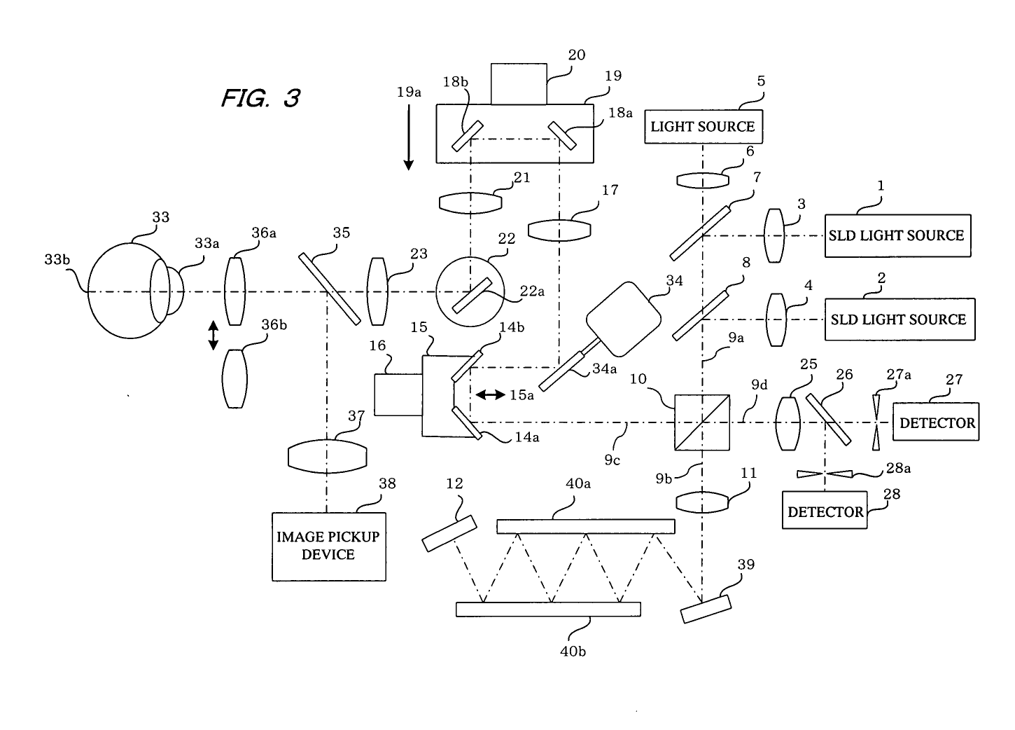

FIG. 3 shows, as another embodiment of the present invention, a configuration of an optical system that is different from the optical system of FIG. 1. In FIG. 3, an anterior eye segment 33a or eye fundus 33b of an eye 33 to be examined, which is a unique organ in a biological body, is assumed to be the observation object. In FIG. 3, optical elements that are the same as the structural elements of FIG. 1 share the reference numerals thereof. The detailed descriptions of the configuration and function are the same as those of FIG. 1, and are accordingly omitted.

In FIG. 3, the light beam from the light source 1 or 2 for tomographic observation is divided in the beam splitter 10 between a reference light optical path 9b and a probe light optical path 9c. The probe light is made incident on the mirrors 14a and 14b and is folded. As in the embodiment relating to FIG. 1, the mirrors 14a and 14b are fixed to a piezoelectric element (piezoelectric vibrator) 16 by a fixing member 15, and the light beam is modulated (frequency-shifted) by high-frequency micro-vibrations of the vibrator 16 in the direction of the optical axis (arrow 15a).

Probe light that passes through the modulating means is made incident on a galvanomirror 34a mounted to a galvanometer 34, and is one-dimensionally swept in the direction orthogonal to the page space of FIG. 3 along the optical axis. This scanning light is reflected by mirrors 18a and 18b via a lens 17, is directed to the galvanomirror 22a of the galvanometer 22 via a lens 21, and is swept in the direction parallel to the page space (the direction orthogonal to the sweeping direction of the galvanomirror 34a). As in the embodiment of FIG. 1, the reflecting mirrors 18a and 18b are fixed to a stepping motor 20 by a fixing member 19 that includes a movement stage, and can perform the sweeping in the direction of the optical axis (arrow 19a).

A sweeping mechanism that uses two galvanomirrors 34a and 22a is used to enable sweeping of the light beam in an arbitrary direction orthogonal to the optical axis of the eye fundus of the eye to be examined, for example. In addition the intermediately disposed lenses 17 and 21 constitute a telecentric optical system so that the light beam travels parallel to the optical axis in the position of the mirrors 18a and 18b attached to the sweeping mechanism.

The light beam swept by the galvanomirrors in an arbitrary direction orthogonal to the optical axis is guided in the direction of the lens 23, penetrates a beam splitter 35, and is directed via a lens 36a (or a lens 36b) on a predetermined position on the eye 33 to be examined. A lens 37 and an image pickup device 38 (e.g., two-dimensional CCD) are provided at a location along the direction split by the beam splitter 35 in the direction orthogonal to the optical axis of the eye to be examined. The image pickup device 38 is used to secondarily monitor the eye to be examined when the present OCT device is in operation.

The lenses 36a and 36b that face the eye to be examined have different focal point distances, and the lenses are intended to be switched according to the wavelength of the light source. The eyeball tissues exhibit different light absorption characteristics for each wavelength. Therefore, light from the light source 2 that has a wavelength of 850 nm is suitable for viewing a tomographic picture of the eye fundus at a high resolution, while light from the light source 1 that has a wavelength of 1300 nm is suitable for viewing the angulus iridocornealis and other structures of the eye to be examined at a favorable resolution. If the lenses 36a and 36b is automatically selected in accordance with the selection of the light source and detector by the computer 30 (FIG. 2), a tomographic image having consistently superior resolution and contrast can be advantageously observed in accordance with the location of the observation object, and the device will be easy to handle.

In FIG. 3, the reflected light from the predetermined location on the eye 33 to be examined travels backward along the above-described optical path, is combined in the optical path 9d in the beam splitter 10 with reference light on the reference light optical path, and interference light is generated in the same manner as in the embodiment in FIG. 1. The interference signal that corresponds to the interference light is detected by the detector 27 or 28. Predetermined openings (pinholes) 27a and 28a are provided at a front surface of the detectors 27 and 28. This enables unnecessary noise to be eliminated, thus improving the SN ratio of the interference signal.

The signal processing circuit 29 (see FIG. 2) selects and processes a signal from either of the detectors 27 and 28 depending upon the selection of the light sources 1 and 2, extracts the intensity data of the reflected light of the interior of the object from the interference signal, and feeds the results to the computer 30. The reflection intensity data is successively fed to the computer 30 in accordance with the two-dimensional scan by the light beam performed by the galvanomirrors 34a and 22a and the three-dimensional scan in the direction of the optical axis performed by the mirrors 18a and 18b. Therefore, the computer 30 reconstructs a three-dimensional cross-sectional picture data of the object from the reflection intensity data of the scanned points thereof in synchronism with the three-dimensional scans with the light beam, and displays the image on the display device 32, or stores the image in the storage 31.

In FIG. 3, the optical path of the reference light is shown in a form that is closer to the actual placement than in the embodiment of FIG. 1. In other words, the light beam of the reference light is reflected by the mirror 39, is reflected back and forth between the mirrors 40a and 40b (light guide means) to gain optical path length, and is subsequently reflected by the mirror 12 and sent back through the optical path of the reference light. The mirrors 12, 39, 40a and 40b are fixed mirrors composed of static components, and three out of the four optical paths of the interferometer are completely fixed when the interferometer is viewed with the beam splitter 10 as the center. Therefore, in an optical system such as the present embodiment, the optical path 9c of the probe light is the only path that includes mechanically moving components, as is the same in the embodiment of FIG. 1. Advantages are accordingly presented in that fluctuations in the interference characteristics of the light that accompany mechanical scanning are less likely to occur, and optical adjustments can also be performed in a straightforward manner.

When the eye to be examined is secondarily observed with the image pickup device 38 as described, the distance of the focal point of the lens 37 is automatically adjusted in accordance with the selection of the wavelength of the light sources 1 and 2 and a secondary light source (not shown) is introduced from the periphery of the lens 37 so as to enable either the anterior eye segment or the eye fundus to be observed. A two-dimensional CCD camera was assumed to be the image pickup device 38; however, if cost is not a prohibitive factor, it shall be apparent that it will also be possible to produce a configuration in which a scanning-laser opthamaloscope (SLO) or another specialized high-resolution, high-sensitivity two-dimensional imaging system is incorporated into and linked to the unit relating to the image pickup device 38.

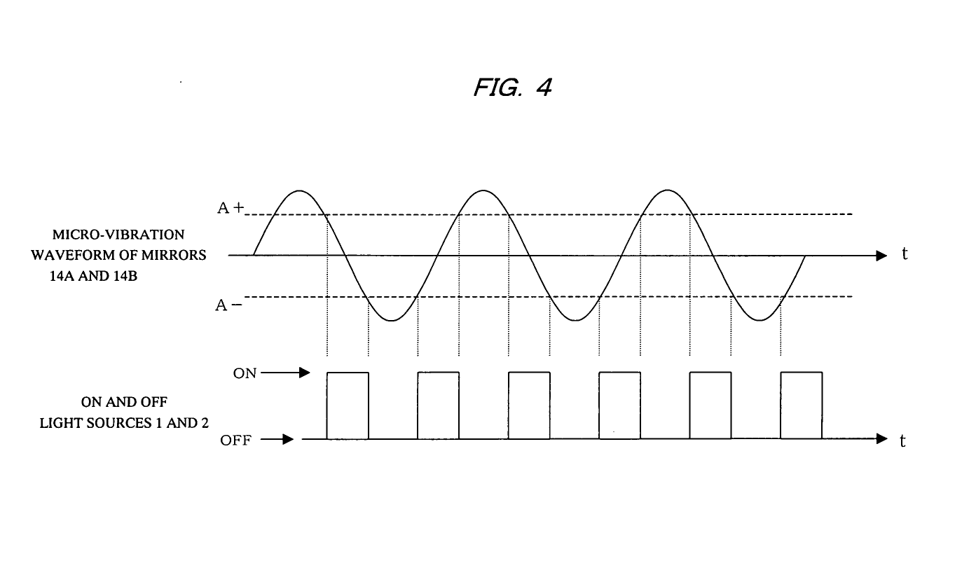

FIG. 4 is a graph showing the relationship between the movement of the mirror that performs modulation via micro-vibration and the state of light emitted by the light source. In embodiments in FIGS. 1 and 3, the mirrors 14a and 14b are endowed with high-speed micro-vibrations by the piezoelectric element 16, inevitably causing the mirrors to move in the form of a sine wave. However, the modulation effect of shifting the frequency of the movement of the sine wave form changes over time. Such conditions are unfavorable for efficiently detecting the interference signal and improving the resolution in the direction of the optical axis. Therefore, the light emitted from the light source 1 or 2 in the embodiments in FIGS. 1 and 3 is controlled depending upon the movement of the mirrors 14a and 14b so that the emission of light may be enabled within a range in which the frequency shift can occur in a stable manner and it is disenabled within all other ranges, as is shown in FIG. 4. The control range in which the emission of light is turned on is indicated for descriptive purposes in the graph of the sine wave curve in FIG. 4 as a range where the amplitude is from A+ to A−. A range where the amplitude is from A+ to A− is set to be a distance that is determined according to the wavelength and coherence length of the light sources 1 and 2 and is smaller than the resolution in the depth direction. Such a control of the emission of the light source enables the utilization efficiency of the light intensity with respect to the detection signal to be improved and the power of light directed on the observation object to be minimized. This is particularly effective when the intensity of emittable light is limited, such as in ophthalmologic examination equipment.

What is claimed is:

1. An optical tomograph for obtaining tomographic imaging data of an observation object by scanning a prescribed region thereof with a light beam from a light source, and detecting and processing reflected light from said object by using optical interference; the optical tomograph comprising:
a light source for generating a low-interference light beam;
an optical splitting element for splitting the light beam from said light source into probe light toward the object and reference light toward a fixed reflective surface;
light modulation means for shifting the frequency of the beam of said probe light;
movement means for moving said frequency-shifted light beam in the direction of the optical axis;
sweeping means for sweeping said frequency-shifted light beam in a direction orthogonal to the optical axis;
detecting means for detecting interference light obtained from the reflected light from the object that has passed through said sweeping means, movement means, light modulation means and optical splitting element and interferes with the reference light that is reflected by said fixed reflective surface and guided via the optical splitting element; and
processing means for processing a time-based interference signal obtained from the detecting means in accordance with the movement of the light beam in the direction of the optical axis and the sweeping in a direction orthogonal to the optical axis to derive therefrom reflection intensity data of the interior of the object.

2. An optical tomograph according to claim 1, wherein the light modulation means has a piezoelectric vibrator that is provided with two reflecting mirrors for folding an optical path, and optically modulates the light beam by endowing the beam with micro-vibrations in the direction of the optical axis.

3. An optical tomograph according to claim 1, wherein the light beam is moved in the direction of the optical axis so as to make the length of the optical path of the probe light up to a focal point on the object equal to the length of the optical path of the reference light up to the fixed reflective surface.

4. An optical tomograph according to claim 1, wherein the light source is turned off outside of a range in which the frequency shift is constant.

5. An optical tomograph for obtaining tomographic imaging data of an observation object by scanning a prescribed region thereof with a light beam from a light source, and detecting and processing reflected light from said object by using optical interference; the optical tomograph comprising:
a light source for generating a low-interference light beam of two or more differing wavelengths;
an optical splitting element for splitting the light beam from said light source into probe light toward the object and reference light toward a fixed reflective surface;
light modulation means for shifting the frequency of the beam of the probe light;
movement means for moving said frequency-shifted light beam in the direction of the optical axis;
sweeping means for at least one-dimensionally sweeping said frequency-shifted light beam in a direction orthogonal to the optical axis;
light-guide means that is disposed between said optical splitting element and fixed reflective surface to set its optical path length equal to the length of the optical path traveled by said probe light;
two or more detecting means tuned to the wavelength of the light source for detecting interference light obtained from the reflected light from the object that has passed through said sweeping means, movement means, light modulation means and optical splitting element and interferes with the reference light that is guided via the fixed reflective surface, light-guide means and optical splitting element; and
processing means for processing a time-based interference signal obtained from the detecting means in accordance with the movement of the light beam in the direction of the optical axis and the sweeping in a direction orthogonal to the optical axis to derive therefrom reflection intensity data of the interior of the object.

6. An optical tomograph according to claim 5, wherein said movement means moves two reflective mirrors in the direction of the optical axis along the optical path of the probe light at a lower rate than said sweeping means in order to move the light beam in the direction of the optical axis.

7. An optical tomograph according to claim 5, wherein the movement means moves the light beam in the direction of the optical axis so as to make the length of the optical path of the probe light up to a focal point on the object equal to the length of the optical path of the reference light up to the fixed reflective surface.

8. An optical tomograph according claim 5, wherein the light source is turned off outside of a range in which the frequency shift is constant.

9. An optical tomograph according to claim 5, wherein a light source is selected in accordance with the type of object and a corresponding detector is selected in accordance with the selection of the light source.
